(19) United States
(12) Patent Application Publication
(10) Pub. No.: US 2023/0289942 A1
(43) Pub. Date: Sep. 14, 2023

(54) IMAGE PROCESSING METHOD, OPTICAL COMPENSATION METHOD, AND OPTICAL COMPENSATION SYSTEM

(71) Applicant: Samsung Display Co., LTD., Yongin-si (KR)

(72) Inventors: Hyun Seuk YOO, Yongin-si (KR); Min Gyu KIM, Yongin-si (KR); Hee Joon KIM, Yongin-si (KR); Jae Seok CHOI, Yongin-si (KR)

(73) Assignee: Samsung Display Co., LTD., Yongin-si (KR)

(21) Appl. No.: 18/117,662

(22) Filed: Mar. 6, 2023

(30) Foreign Application Priority Data
Mar. 8, 2022 (KR) 10-2022-0029655

(51) Int. Cl. G06T 7/00; G06T 5/00; G06T 5/50; G09G 3/32

(52) U.S. Cl. CPC G06T 7/0002; G06T 5/002; G06T 5/003; G06T 5/005; G06T 5/50; G09G 3/32; G06T 2207/20081; G06T 2207/30168; G09G 2300/0819; G09G 2300/0842; G09G 2320/0233; G09G 2320/0295

(57) ABSTRACT

An optical compensation method includes displaying a first image in a display device, the first image including a dot pattern obtained by allowing target pixels spaced apart from each other emit light, at least two other pixels being disposed between the target pixels; generating first image capture data by capturing the first image displayed in the display device through an image capture device; displaying a second image in the display device; generating second image capture data by capturing the second image displayed in the display device through the image capture device; generating deblurring data by deblurring the second image capture data, based on the first image capture data; generating compensation data for luminance correction of the display device, based on the deblurring data; and storing the compensation data in a memory device.

### CROSS-REFERENCE TO RELATED APPLICATION

The application claims priority to and benefit of Korean patent application No. 10-2022-0029655 under 35 U.S.C. § 119(a), filed on Mar. 8, 2022, in the Korean Intellectual Property Office (KIPO), the entire contents of which are incorporated herein by reference.

### BACKGROUND

### 1. Technical Field

The disclosure generally relates to an image processing method, an optical compensation method, and an optical compensation system.

### 2. Related Art

As interest in information displays and demand for portable information media increase, research and commercialization has focused on display devices.

### SUMMARY

Embodiments provide an image processing method, an optical compensation method, and an optical compensation system, which can generate an appropriate compensation data (or compensation value) for luminance correction (or mura compensation) in a display device which has a low correlation between adjacent pixels or hardly has any correlation.

In accordance with an aspect of the disclosure, there is provided an optical compensation method including displaying a first image in a display device, wherein the first image includes a dot pattern obtained by allowing target pixels spaced apart from each other emit light, at least two other pixels being disposed between the target pixels; generating first image capture data by capturing the first image displayed in the display device through an image capture device; displaying a second image in the display device; generating second image capture data by capturing the second image displayed in the display device through the image capture device; generating deblurring data by deblurring the second image capture data, based on the first image capture data; generating compensation data for luminance correction of the display device, based on the deblurring data; and storing the compensation data in a memory device.

The first image may include areas divided with respect to a reference block. In each of the areas, a target pixel among the target pixels may emit light, and adjacent pixels adjacent to the target pixel may emit no light, thereby expressing the dot pattern.

The dot pattern may be blurredly captured according to at least one of an image capture condition and a resolution of the image capture device. The first image capture data may include a blurred dot pattern corresponding to the dot pattern.

The generating of the deblurring data may include detecting blur information representing a degree to which the dot pattern is blurred in an image captured by the image capture device, based on the first image capture data; and deblurring the second image capture data, based on the blur information.

The detecting of the blur information may include deriving a weight matrix for converting the blurred dot pattern included in the first image capture data into an ideal dot pattern.

The deriving of the weight matrix may include calculating a first weighted value for a target pixel among the target pixels corresponding to the dot pattern and a second weighted value for adjacent pixels adjacent to the target pixel through machine learning on the blurred dot pattern. The first weighted value and the second weighted value may be included in the weight matrix.

A gradient descent algorithm may be used for the machine learning.

The deriving of the weight matrix may include calculating deblurring dot data including a deblurring dot pattern by using the weight matrix; calculating an error between ideal dot data including an ideal dot pattern and the deblurring dot data; and adjusting the first weighted value and the second weighted value, based on the error.

The deriving of the weight matrix may include repeating the calculating of the error and the adjusting of the first weighted value and the second weighted value such that the error is minimized.

In the calculating of the error, the error may be calculated by normalizing the first image capture data.

The generating of the deblurring data may further include generating first deblurring data by deblurring the second image capture data; detecting a noise through a spatial frequency analysis on the first deblurring data, the noise being a deblurred value out of a reference range in the deblurring of the second image capture data; and replacing the noise with a value corresponding to the second image capture data.

The generating of the first image capture data may include converting a resolution of an image captured by the image capture device to be substantially equal to a resolution of the display device.

The compensation data stored in the memory device may be used for luminance deviation compensation in driving of the display device.

In accordance with another aspect of the disclosure, there is provided an image processing method of preprocessing a capture image for optical compensation of a display device, the image processing method including detecting blur information representing a degree to which a dot pattern is blurred in a first capture image including the dot pattern; and deblurring a second capture image, based on the blur information.

The detecting of the blur information may include deriving a weight matrix for converting the blurred dot pattern included in the first capture image into an ideal dot pattern.

The deriving of the weight matrix may include calculating a first weighted value for a target pixel corresponding to the dot pattern and a second weighted value for adjacent pixels adjacent to the target pixel through machine learning on the blurred dot pattern. The first weighted value and the second weighted value may be included in the weight matrix.

A gradient descent algorithm may be used for the machine learning.

The deriving of the weight matrix may include generating a deblurring dot image including a deblurring dot pattern by using the weight matrix; calculating an error between an ideal dot image including an ideal dot pattern and the deblurring dot image; and adjusting the first weighted value and the second weighted value, based on the error.

The deblurring of the second captured image may further include generating a first deblurring image by deblurring the second capture image; detecting a noise through a spatial frequency analysis on the first deblurring image, the noise being a deblurred value out of a reference range in the deblurring of the second capture image; and replacing the noise with a value corresponding to the second capture image.

In accordance with still another aspect of the disclosure, there is provided an optical compensation system including an image capture device that generates image capture data by capturing an image displayed in a display device; and a luminance correction device that generates compensation data for luminance correction of the display device, based on the image capture data, wherein the luminance correction device detects blur information representing a degree to which a dot pattern is blurred in first image capture data including the dot pattern, and deblurs second image capture data, based on the blur information.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will more fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a schematic diagram illustrating an optical compensation system in accordance with embodiments of the disclosure.

FIG. 2 is a schematic diagram illustrating accuracy of a captured image according to resolutions of an image capture device included in the optical compensation system shown in FIG. 1.

FIG. 3 is a schematic diagram illustrating luminance interference ratios between pixels according to resolutions of the image capture device.

FIG. 4 is a schematic diagram illustrating an embodiment of a display device included in the optical compensation system shown in FIG. 1.

FIG. 5 is a schematic block diagram illustrating an embodiment of a luminance correction device included in the optical compensation system shown in FIG. 1.

FIG. 6 is a schematic block diagram illustrating another embodiment of the luminance correction device included in the optical compensation system shown in FIG. 1.

FIG. 7 is a schematic diagram illustrating an embodiment of a deblurring block included in the luminance correction device shown in FIG. 5.

FIG. 8 is a schematic diagram illustrating an embodiment of first image capture data used in the deblurring block shown in FIG. 7.

FIGS. 9 and 10 are schematic diagrams illustrating an operation of a weight matrix generator included in the deblurring block shown in FIG. 7.

FIG. 11 is a schematic diagram illustrating an embodiment of the weight matrix generator included in the deblurring block shown in FIG. 7.

FIG. 12 is a schematic diagram illustrating a process of calculating an error in the weight matrix generator shown in FIG. 11.

FIG. 13 is a schematic diagram illustrating an operation of a calculator included in the deblurring block shown in FIG. 7.

FIGS. 14 and 15 are schematic diagrams illustrating another embodiment of the deblurring block included in the luminance correction device shown in FIG. 5.

FIG. 16 is a schematic diagram illustrating an operation of a noise canceller included in the deblurring block shown in FIGS. 14 and 15.

FIGS. 17 to 19 are schematic diagrams illustrating an effect of deblurring on image capture data.

FIGS. 20A and 20B are schematic diagrams of equivalent circuits illustrating an embodiment of a pixel included in the display device shown in FIG. 4.

FIG. 21 is a schematic perspective view illustrating a light emitting element included in the pixel shown in FIG. 20A.

FIG. 22 is a schematic flowchart illustrating an optical compensation method in accordance with embodiments of the disclosure.

FIG. 23 is a schematic flowchart illustrating a process of deblurring second image capture data shown in FIG. 22.

FIG. 24 is a schematic flowchart illustrating a process of deriving a weight matrix shown in FIG. 23.

### DETAILED DESCRIPTION OF THE EMBODIMENTS

The disclosure may apply various changes and different shape, therefore only illustrate in detail with particular examples. However, the examples do not limit to certain shapes but apply to all the change and equivalent material and replacement. The drawings included are illustrated a fashion where the figures are expanded for the better understanding.

Like numbers refer to like elements throughout. In the drawings, the thickness of certain lines, layers, components, elements or features may be exaggerated for clarity. It will be understood that, although the terms “first”, “second”, and the like may be used herein to describe various elements, these elements should not be limited by these terms. These terms are only used to distinguish one element from another element. Thus, a “first” element discussed below could also be termed a “second” element without departing from the teachings of the disclosure. As used herein, the singular forms are intended to include the plural forms as well, unless the context clearly indicates otherwise.

It will be further understood that the terms “include,” “comprise,” “have” and/or their variants, when used in this specification, specify the presence of stated features, integers, steps, operations, elements, and/or components, but do not preclude the presence and/or addition of one or more other features, integers, steps, operations, elements, components, and/or groups thereof.

Some embodiments are described in the accompanying drawings in relation to functional blocks, units, and/or modules. Those skilled in the art will understand that these blocks, units, and/or modules are physically implemented by logic circuits, individual components, microprocessors, hard wire circuits, memory elements, line connection, and other electronic circuits. This may be formed by using semiconductor-based manufacturing techniques or other manufacturing techniques. In the case of blocks, units, and/or modules implemented by microprocessors or other similar hardware, the units, and/or modules are programmed and controlled by using software, to perform various functions discussed in the disclosure, and may be selectively driven by firmware and/or software. In addition, each block, each unit, and/or each module may be implemented by dedicated hardware or by a combination dedicated hardware to perform some functions of the block, the unit, and/or the module and a processor (e.g., one or more programmed microprocessors and associated circuitry) to perform other functions of the block, the unit, and/or the module. In some embodiments, the blocks, the units, and/or the modules may be physically separated into two or more individual blocks, two or more individual units, and/or two or more individual modules without departing from the scope of the disclosure. Also, in some embodiments, the blocks, the units, and/or the modules may be physically separated into more complex blocks, more complex units, and/or more complex modules without departing from the scope of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

The terms “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value.

The term “and/or” includes all combinations of one or more of which associated configurations may define. For example, “A and/or B” may be understood to mean “A, B, or A and B.”

The phrase “at least one of” is intended to include the meaning of “at least one selected from the group of” for the purpose of its meaning and interpretation. For example, “at least one of A and B” may be understood to mean “A, B, or A and B.”

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

Hereinafter, embodiments of the disclosure and items required for those skilled in the art to readily understand the content of the disclosure will be described in detail with reference to the accompanying drawings. In the following description, singular forms in the disclosure are intended to include the plural forms as well, unless the context clearly indicates otherwise.

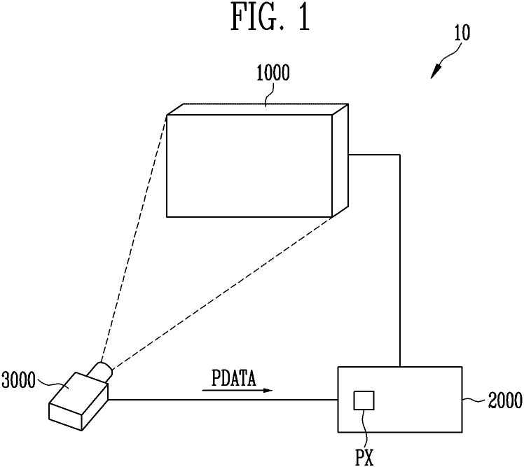

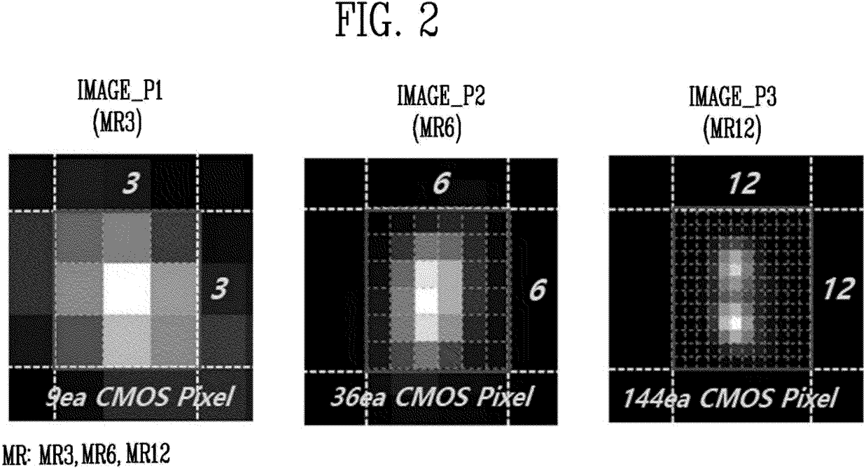

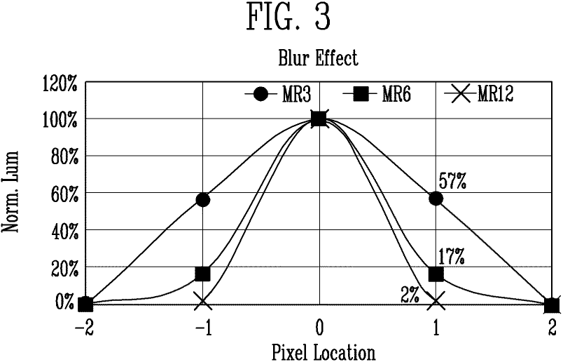

FIG. 1 is a schematic diagram illustrating an optical compensation system in accordance with embodiments of the disclosure. FIG. 2 is a schematic diagram illustrating accuracy of a captured image according to resolutions of an image capture device included in the optical compensation system shown in FIG. 1. FIG. 3 is a schematic diagram illustrating luminance interference ratios between pixels according to resolutions of the image capture device.

First, referring to FIG. 1, an optical compensation system 10 (luminance correction system or image processing system) may include an image capture device 3000 and a luminance correction device 2000 (or image processing device). In some embodiments, the optical compensation system 10 may include a display device 1000.

The image capture device 3000 may be disposed to face the display device 1000 for the purpose of luminance correction of the display device 1000.

The image capture device 3000 may capture a display surface of the display device 1000 or an image displayed on the display device 1000, and provide the luminance correction device 2000 with the captured image, for example, image capture data PDATA. For example, the image capture device 3000 may include a light receiving element such as a charge-coupled device (CCD) camera or a complementary metal-oxide semiconductor (CMOS) sensor. For example, the image capture device 3000 may provide the luminance correction device 2000 with a single image frame generated by capturing an image on the display surface of the display device 1000 once. In another example, the image capture device 3000 does not include any light receiving element, but may be connected to an external light receiving element. The image capture device 3000 may be configured to receive a single image frame which the external light receiving element captures once.

A resolution of the image capture data PDATA may rely on a resolution of the light receiving element, and a resolution of the image may rely on a resolution of pixels of the display device 1000. In case that the resolution of the light receiving element corresponds to the resolution of the pixels, coordinates of the image capture data PDATA and coordinates of the image may correspond to each other at a ratio of about 1:1. In case that the resolution of the light receiving element is lower than the resolution of the pixels, coordinates of the single image frame and the coordinates of the image may correspond to each other at a ratio of about 1:a. Here, a may be a real number greater than 1. In case that the resolution of the light receiving element is higher than the resolution of the pixels, the coordinates of the image capture data PDATA and the coordinates of the image may correspond to each other at a ratio of about b:1. Here, b is a real number greater than 1.

Values of the image capture data PDATA may correspond to luminance values of the image. For example, in case that luminance values of specific coordinates of the image are relatively high, the values of the image capture data PDATA may also be relatively high. The values of the image capture data PDATA may be determined according to the resolution of the light receiving element.

The luminance correction device 2000 may control an operation of the display device 1000 (or display panel). For example, the luminance correction device 2000 may control the display device 1000 such that a specific image is displayed in (or on) the display device 1000.

The luminance correction device 2000 may generate a compensation value (or compensation data) for luminance correction of the display device 1000, based on the image capture data PDATA. The luminance correction device 2000 may be implemented as an application processor or the like.

In embodiments, the luminance correction device 2000 may acquire blur information, based on the image capture data PDATA, and deblur the image capture data PDATA, based on the blur information. The blur information may mean a degree to which a captured image is blurred. For example, the blur information may mean a degree to which a dot pattern of light emitted from only a pixel is blurred in the captured image. The blur information may be changed according to a resolution of the image capture device 3000, an image capture condition, and the like.

For example, the luminance correction device 2000 may acquire blur information by using first image capture data about a first image (or dot image) including a dot pattern, and deblur second image capture data about a second image (or image for measuring a luminance deviation), based on the blur information, thereby generating deblurring data.

For example, the luminance correction device 2000 may derive a weight matrix for correcting the blurred dot pattern to an ideal dot pattern, based on the first image capture data, and generate deblurring data by applying the weight matrix to the second image capture data. An inverse matrix of the weight matrix may correspond to the blur information. The deblurring data may have image capture accuracy similar to image capture accuracy of image capture data acquired through a high-resolution image capture device.

Referring to FIG. 2, a first capture image IMAGE_P1 may represent an image obtained by capturing a pixel PX (or sub-pixel) in the display device 1000, by using 3×3 light receiving elements (e.g., CMOS pixels). For example, a pixel PX of the display device 1000 may correspond to 3×3 light receiving elements in the first capture image IMAGE_P1, and the magnification ratio MR of the image capture device 3000 may be about 3 (for example, MR3). A second capture image IMAGE_P2 may represent an image obtained by capturing a pixel PX in the display device 1000, using 6×6 light receiving elements. For example, a pixel PX of the display device 1000 may correspond to 6×6 light receiving elements in the second capture image IMAGE_P2, and the magnification ratio MR of the image capture device 3000 may be about 6 (for example, MR6). A third capture image IMAGE_P3 may represent an image, obtained by capturing a pixel PX in the display device 1000, by using 12×12 light receiving elements. For example, a pixel PX of the display device 1000 may correspond to 12×12 light receiving elements in the third capture image IMAGE_P3, and the magnification ratio MR of the image capture device 3000 may be about 12 (for example, MR12).

For example, a pixel PX may include two light sources (for example, two light sources which simultaneously emit light in response to a same data signal), and it may be assumed that only a pixel PX emits light and pixels adjacent to the pixel PX emit no light. In the third capture image IMAGE_P3, two light sources are distinguished from each other, and accordingly, a luminance of a pixel PX (further, a luminance of each of the two light sources) can be accurately measured by using the third capture image IMAGE_P3. In the second capture image IMAGE_P2, two light sources are not distinguished from each other, but a luminance distribution exhibits roughly in a pixel area. Accordingly, a luminance of a pixel PX can be relatively accurately measured by using the second capture image IMAGE_P2. In the first capture image IMAGE_P1, a luminance distribution caused by light emitted from the pixel PX exhibits even in an adjacent pixel area out of a pixel area (for example, a blur occurs), and accuracy may be low in case that a luminance of a pixel PX is measured by using the first capture image IMAGE_P1.

Referring to FIG. 3, ratios at which a luminance of a light emitting pixel is interfered with an adjacent pixel according to resolutions of the image capture device 3000 are illustrated. A pixel position of the light emitting pixel is about 0, and a unit of the pixel position may correspond to a number of pixels. For example, a pixel position of 1 may mean a pixel firstly adjacent to the light emitting pixel, and a pixel position of 2 may mean a pixel secondly adjacent to the light emitting pixel.

In case that the magnification ratio of the image capture device 3000 is about 3 (for example, MR3), it may appear that the luminance (image or dot image) of the light emitting pixel is diffused or blurred to a degree of about 57% into an adjacent pixel. In case that the magnification ratio of the image capture device 3000 is about 6 (for example, MR6), it may appear that the luminance (image or dot image) of the light emitting pixel is diffused or blurred to a degree of about 17% into an adjacent pixel. In case that the magnification ratio of the image capture device 3000 is about 12 (for example, MR12), it may appear that the luminance (image or dot image) of the light emitting pixel is diffused or blurred to a degree of about 2% into an adjacent pixel.

For example, as the magnification ratio of the image capture device 3000 becomes higher, only the luminance of the light emitting pixel can be accurately measured. However, as the magnification ratio of the image capture device 3000 becomes higher, the image capture device 3000 may be high-priced, or image capture performed in plural times instead of once may be required to measure a luminance with respect to the entire area of the display device 1000. For example, in case that the magnification ratio of the image capture device 3000 is about 3 (for example, MR3), the luminance with respect to the entire area of the display device 1000 may be measured once. In case that the magnification ratio of the image capture device 3000 is about 6 (for example, MR6), the entire area of the display device 1000 may be divided into at least four areas, and a luminance of each of the areas may be measured. In case that the magnification ratio of the image capture device 3000 is about 12 (for example, MR12), the entire area of the display device 1000 may be divided into at least 16 areas, and a luminance of each of the areas may be measured. Therefore, an image capture time (and a time required to perform optical compensation according thereto) may increase, and manufacturing cost of the display device 1000 may increase.

Accordingly, the optical compensation system (or manufacturing equipment) may perform deblurring on a capture image (or capture data) so as to minimize an increase in cost of the optical compensation system 10 or manufacturing cost of the display device 1000 and to improve accuracy of the capture image.

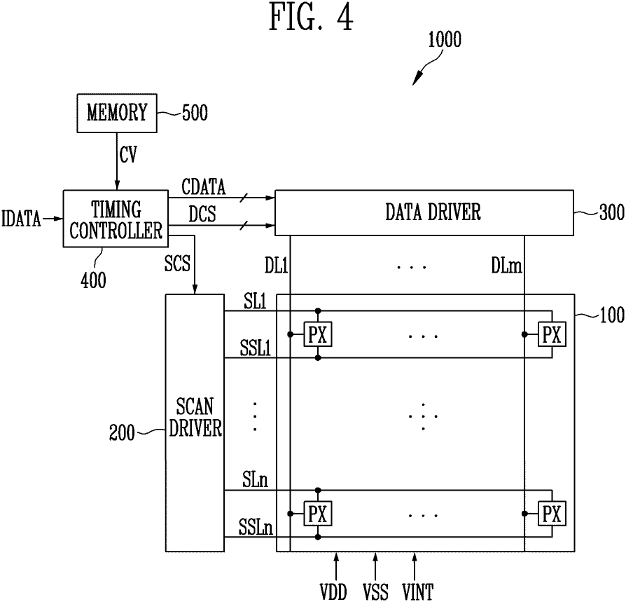

FIG. 4 is a schematic diagram illustrating an embodiment of the display device included in the optical compensation system shown in FIG. 1.

Referring to FIG. 4, the display device 1000 may include a display panel 100, a scan driver 200, a data driver 300, a timing controller 400, and a memory 500.

The display device 1000 may be implemented as an inorganic light emitting display device, and include, for example, a flexible display device, a rollable display device, a curved display device, a transparent display device, a mirror display device, and the like. In an example, the display device 1000 may be implemented as a display device including light emitting elements having a size of nanometer scale to micrometer scale. However, the display device 1000 is not limited thereto, and may include an organic light emitting element.

The display panel 100 may include pixels PX, and display an image. Specifically, the display panel 100 may include pixels PX disposed to be connected to scan lines SL1 to SLn and data lines DL1 to DLm. The pixels PX may be connected to sensing lines SSL1 to SSLn.

In an embodiment, each of the pixels PX may emit light of one of red, green, and blue. However, this is merely illustrative, and each of the pixels PX may emit light of cyan, magenta, yellow, or the like. A first driving voltage VDD and a second driving voltage VSS may be supplied to the display panel 100 to be applied to the pixels PX. In some embodiments, an initialization voltage VINT may be further supplied to the display panel 100 so as to initialize the pixels PX.

The scan driver 200 may provide a scan signal to the pixels PX of the display panel 100 through the scan lines SL1 to SLn. The scan driver 200 may provide a scan signal to the display panel 100, based on a scan control signal SCS received from the timing controller 400.

The data driver 300 may provide a data signal to which image data CDATA is applied to the pixels PX of the display panel 100 through the data lines DL1 to DLm. The data driver 300 may provide a data signal (or data voltage) to the display panel 100, based on a data driving control signal DCS received from the timing controller 400. In an embodiment, the data driver 300 may convert the image data CDATA into a data signal in an analog form.

The timing controller 400 may receive input image data IDATA provided from an external graphic source (e.g., an application processor) or the like, and receive a control signal and the like from the outside to control driving of the scan driver 200 and the data driver 300. The timing controller 400 may generate the scan control signal SCS and the data driving control signal DCS. In an embodiment, the timing controller 400 may generate the image data CDATA, based on the input image data IDATA. For example, the timing controller 400 may convert the input image data IDATA into the image data CDATA to accord with arrangement of the pixels PX in the display panel 100. The image data CDATA may be provided to the data driver 300.

In an embodiment, the timing controller 400 may generate the image data CDATA by compensating for the input image data IDATA, based on a compensation value CV provided from the memory 500. The compensation value CV may be generated in the luminance correction device 2000 and be stored in the memory 500 so as to compensate for a luminance deviation of the display panel 100.

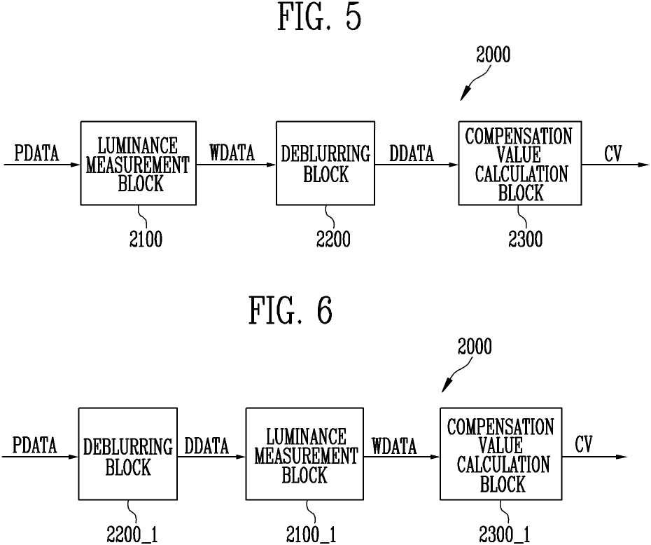

FIG. 5 is a schematic block diagram illustrating an embodiment of the luminance correction device included in the optical compensation system shown in FIG. 1. FIG. 6 is a schematic block diagram illustrating another embodiment of the luminance correction device included in the optical compensation system shown in FIG. 1.

First, referring to FIGS. 1 and 5, the luminance correction device 2000 may include a luminance measurement block 2100 (or resolution conversion block), a deblurring block 2200, and a compensation value calculation block 2300.

The luminance measurement block 2100 may extract a luminance value of each of the pixels PX, based on image capture data PDATA provided from the image capture device 3000.

For example, in case that the luminance measurement block 2100 receives the first capture image IMAGE_P1 (or image capture data corresponding thereto) shown in FIG. 2, the luminance measurement block 2100 may extract a value located at the center among 3×3 values corresponding to a pixel PX.

In other words, the luminance measurement block 2100 may output conversion data WDATA by converting a resolution of the image capture data PDATA (or capture image) to be substantially equal to a resolution of the display device 1000. For example, the luminance measurement block 2100 may convert the resolution of the image capture data PDATA by image warping.

Although it is described that the luminance measurement block 2100 performs the image warping on the image capture data PDATA, the disclosure is not limited thereto. In case that the resolution of the image capture data PDATA is substantially equal to the resolution of the display device 1000, the luminance measurement block 2100 may be omitted.

The deblurring block 2200 may generate deblurring data DDATA by performing deblurring on the conversion data WDATA.

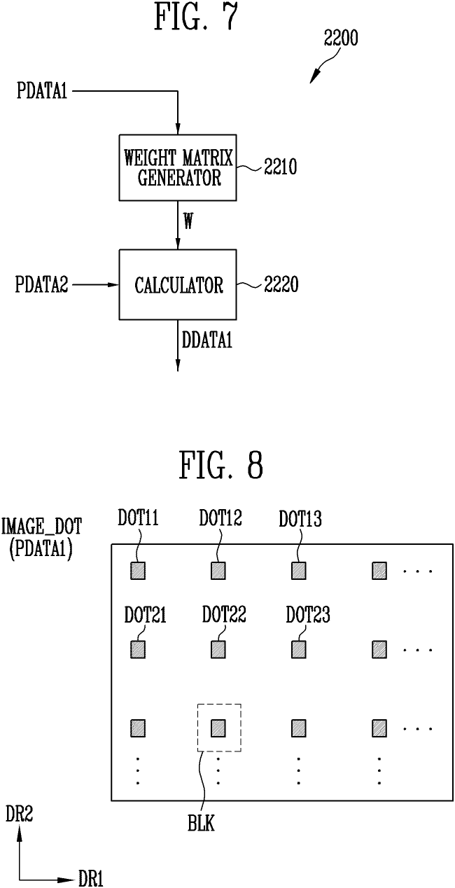

In embodiments, the deblurring block 2200 may derive blur information or a weight matrix, based on the conversion data WDATA, and deblur the conversion data WDATA, based on the blur information or the weight matrix. The deblurring block 2200 will be described later with reference to FIG. 7.

The compensation value calculation block 2300 may calculate a compensation value or a compensation coefficient with respect to each of the pixels PX, based on the deblurring data DDATA. For example, the compensation value may be a grayscale value to be reflected in an input grayscale value with respect to the pixel PX, and the compensation coefficient may be a coefficient of a compensation function for calculating a compensation grayscale value.

For example, the compensation value calculation block 2300 may calculate an average luminance value of the pixels PX, based on the deblurring data DDATA, and calculate a compensation value CV of each of the pixels PX, based on an average luminance and a luminance value of each of the pixels PX. For example, the compensation value calculation block 2300 may determine, as the compensation value CV, a difference between the average luminance and the luminance value of the pixel PX. However, this is merely illustrative, and the disclosure is not limited thereto. The compensation value calculation block 2300 may calculate the compensation value CV by using various optical compensation techniques or various luminance correction (or mura compensation) techniques.

In some embodiments, the luminance correction device 2000 may further include a memory device, and the memory device may store information necessary for an operation of the luminance correction device 2000. For example, the memory device may store the compensation value CV. For example, the memory device may store a weight matrix calculated by the deblurring block 2200, or store a median value or the like, which is calculated in a process of deriving the weight matrix.

Although it is described that the deblurring is performed after the image warping, the disclosure is not limited thereto. For example, as shown in FIG. 6, a deblurring block 2200_1 may generate deblurring data DDATA by deblurring image capture data PDATA, a luminance measurement block 2100_1 may generate conversion data WDATA by converting a resolution of the deblurring data DDATA, and a compensation value calculation block 2300_1 may calculate a compensation value CV, based on the conversion data WDATA.

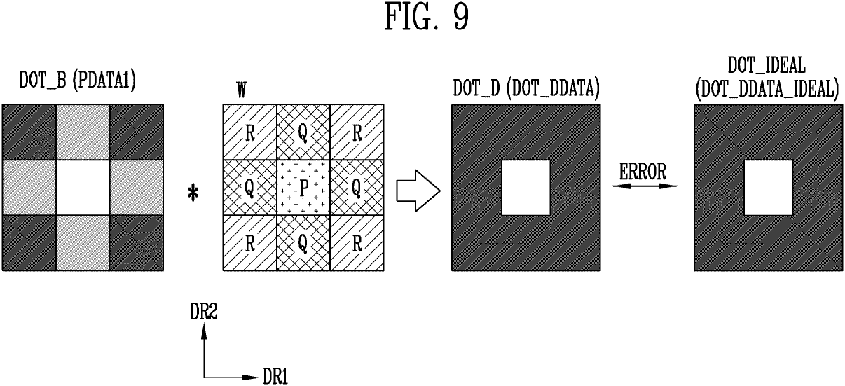

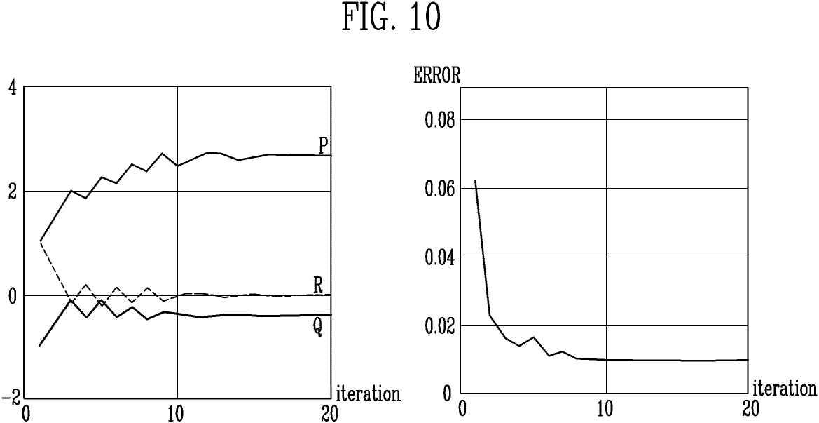

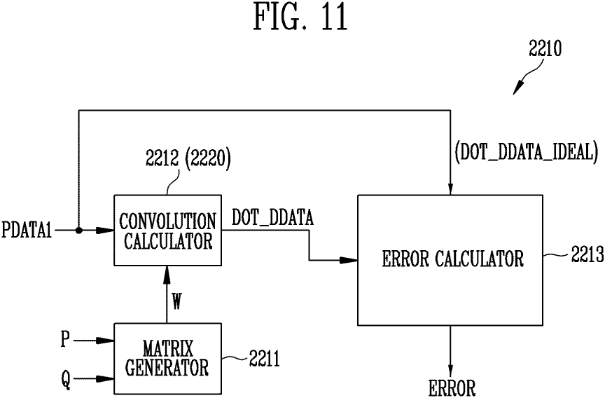

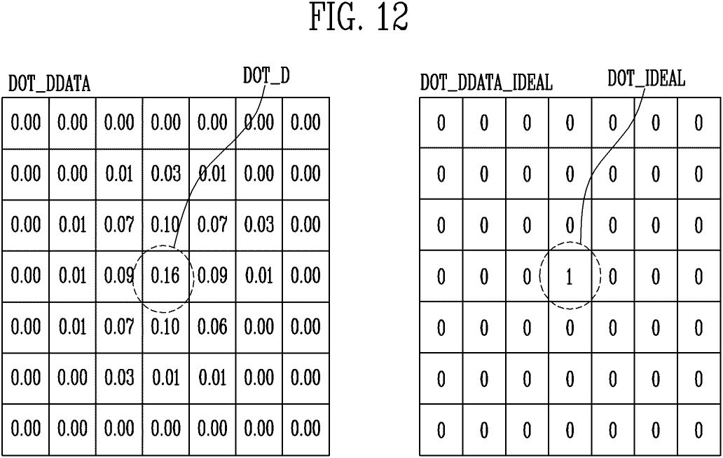

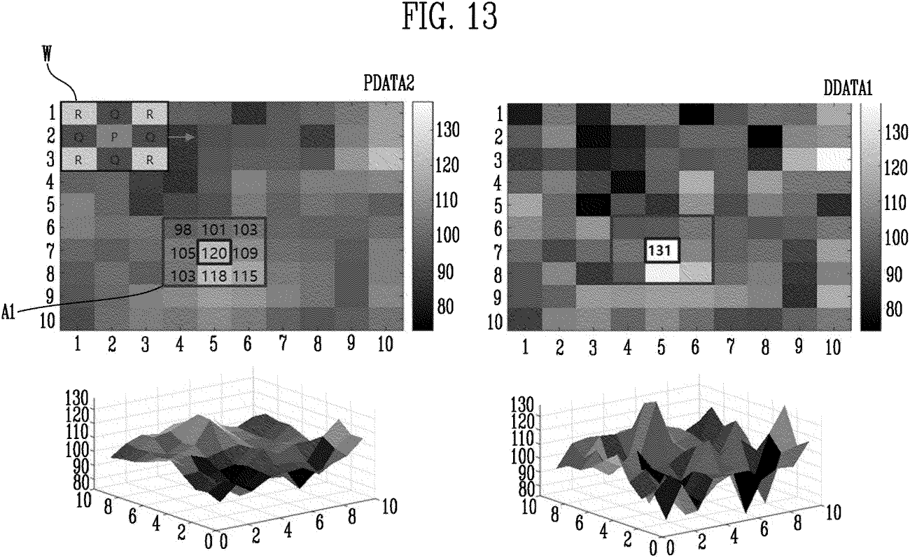

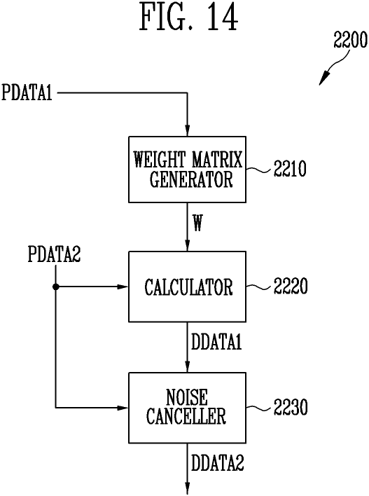

FIG. 7 is a schematic diagram illustrating an embodiment of the deblurring block included in the luminance correction device shown in FIG. 5. FIG. 8 is a schematic diagram illustrating an embodiment of first image capture data used in the deblurring block shown in FIG. 7. FIGS. 9 and 10 are schematic diagrams illustrating an operation of a weight matrix generator included in the deblurring block shown in FIG. 7. FIG. 11 is a schematic diagram illustrating an embodiment of the weight matrix generator included in the deblurring block shown in FIG. 7. FIG. 12 is a schematic diagram illustrating a process of calculating an error in the weight matrix generator shown in FIG. 11. FIG. 13 is a schematic diagram illustrating an operation of a calculator included in the deblurring block shown in FIG. 7.

First, referring to FIGS. 1, 5, and 7, the deblurring block 2200 may include a weight matrix generator 2210 (or blur information detector) and a calculator 2220 (or integrator). The weight matrix generator 2210 will be first described with reference to FIGS. 7 to 12, and the calculator 2220 will be described with reference to FIGS. 7 to 13.

The weight matrix generator 2210 may detect blur information or calculate a weight matrix, based on first image capture data PDATA1.

As shown in FIG. 8, the first image capture data PDATA1 may be an image or data, which is acquired by capturing the display device 1000 (see FIG. 1) displaying a dot image IMAGE_DOT (or first image). The dot image IMAGE_DOT may include dot patterns DOT 11 to DOT 13 and DOT 21 to DOT 23 obtained by allowing only pixels spaced part from each other with at least two pixels interposed (or disposed) therebetween among the pixels PX of the display device 1000 to emit light.

For example, the dot image IMAGE_DOT may include areas divided with respect to a reference block BLK. In each of the areas, only a target pixel among pixels in the display device may emit light, and adjacent pixels adjacent to the target pixel among the pixels may emit no light, so that the dot patterns DOT 11 to DOT 13 and DOT 21 to DOT 23 are expressed.

For example, the reference block BLK may have a size corresponding to 40×40 pixels, and the dot patterns DOT 11 to DOT 13 and DOT 21 to DOT 23 may be spaced apart from each other at a distance corresponding to about 40 pixels in first and second directions DR1 and DR2. For example, a coordinate of an eleventh dot pattern DOT 11 may be (1, 1), a coordinate of a twelfth dot pattern DOT12 may be (1, 41), a coordinate of a twenty-first dot pattern DOT 21 may be (41, 1), and a coordinate of a twenty-second dot pattern DOT 22 may be (41, 41). Positions of the dot patterns DOT 11 to DOT 13 and DOT 21 to DOT 23 may be predetermined or selected. The distance between the dot patterns DOT 11 to DOT 13 and DOT 21 to DOT 23 and the positions of the dot patterns DOT 11 to DOT 13 and DOT 21 to DOT 23 may be variously changed.

In order to express the dot patterns DOT 11 to DOT 13 and DOT 21 to DOT 23, a pixel PX corresponding to each of the dot patterns DOT 11 to DOT 13 and DOT 21 to DOT 23 may emit light at a maximum grayscale (e.g., a grayscale of 255 among grayscales of 0 to 255), but the disclosure is not limited thereto.

In case that the display device 1000 includes color pixels emitting light of different colors, a dot image IMAGE_DOT may be generated for each color, and first image capture data PDATA1 may be generated for each color, corresponding to the dot image IMAGE_DOT. For example, the display device 1000 includes a red pixel emitting light of red, a green pixel emitting light of green, and a blue pixel emitting light of blue, a dot image IMAGE_DOT and first image capture data PDATA1 may be generated with respect to each of red, green, and blue. Accordingly, an operation of deriving a weight matrix and a deblurring operation, which will be described later, may also be performed for each color. However, the disclosure is not limited thereto.

The dot patterns DOT 11 to DOT 13 and DOT 21 to DOT 23 may be blurredly captured according to at least one of a resolution of the image capture device 3000 and an image capture condition, and the first image capture data PDATA1 may include blurred dot patterns DOT_B (see FIG. 9) corresponding to the dot patterns DOT 11 to DOT 13 and DOT 21 to DOT 23. As described with reference to FIG. 5, the image warping may be applied to the first image capture data PDATA1, and a resolution of the first image capture data PDATA1 may be substantially equal to a resolution of the display device 1000.

The blur information may represent a degree to which the dot patterns DOT 11 to DOT 13 and DOT 21 to DOT 23 (or blurred dot patterns DOT_B) are blurred.

In an embodiment, the weight matrix generator 2210 may derive a weight matrix W for converting the blurred dot pattern DOT_B in the first image capture data PDATA1 into an ideal dot pattern DOT_IDEAL.

Referring to FIG. 9, the blurred dot pattern DOT_B may be included in the first image capture data PDATA1, and correspond to each of the dot patterns DOT 11 to DOT 13 and DOT 21 to DOT 23.

The weight matrix generator 2210 may calculate deblurring dot pattern DOT_D (or deblurring dot data DOT_DDATA including the deblurring dot pattern DOT_D) by performing convolution calculation on the blurred dot pattern DOT_B (or the first image capture data PDATA1 including the blurred dot pattern DOT_B) and the weight matrix W, and calculate an error ERROR between the deblurring dot pattern DOT_D (or deblurring dot data DOT_DDATA) and the ideal dot pattern DOT_IDEAL (or ideal dot data DOT_DDATA_IDEAL including the ideal dot pattern DOT_IDEAL). The weight matrix generator 2210 may derive the weight matrix W in which the error ERROR is minimized through machine learning on the blurred dot pattern DOT_B (or first image capture data PDATA1). For example, the weight matrix generator 2210 may derive the weight matrix W in which the error ERROR is minimized, by using a Gradient Descent Algorithm (GDA) as one of machine learning techniques.

For example, the weight matrix W may have a size of 3×3. However, this is merely illustrative, and the size of the weight matrix W may be variously changed. For example, the size of the weight matrix W may be 5×5, 7×7, or the like.

In the weight matrix W, a value of a first entry (or first weighted value) corresponding to the blurred dot DOT_B, for example, a first entry value may be defined or expressed as P, a value of second entries (or second weighted values) located in the first and second directions DR1 and DR2 with respect to the first entry, for example, a second entry value may be defined or expressed as Q, and a value of third entries (or third weighted values) located in a diagonal direction with respect to the first entry, for example, a third entry value may be defined or expressed as R. In case that a relationship between the first, second, and third entries and pixels is expressed, the first entry may correspond to a target pixel expressing the blurred dot pattern DOT_B, and the second and third entries may correspond to adjacent pixels adjacent to the target pixel.

A total sum of the first, second, and third entry values P, Q, and R may be about 1 (for example, P+4Q+4R=1). In case that the first entry value P and the second entry value Q are determined, the third entry value R may be automatically calculated (for example, R=(1-P-4Q)/4).

As shown in FIG. 10, the weight matrix generator 2210 may repeatedly perform a process of calculating the error ERROR and a process of adjusting the first and second entry values P and Q (and the third entry value R according thereto). As a number of times the processes are repeatedly performed increases, the error ERROR may converge while decreasing, and the first and second entry values P and Q (and the third entry value R) may converge to specific values. For example, the weight matrix W in which the error ERROR is minimized may be derived.

In an embodiment, as shown in FIG. 11, the weight matrix generator 2210 may include a matrix generator 2211, a convolution calculator 2212, and an error calculator 2213.

The matrix generator 2211 may receive the first entry value P (or initial first entry value) and the second entry value Q (or initial second entry value), and generate the weight matrix W, based on the first and second entry values P and Q.

The convolution calculator 2212 may generate the deblurring dot data DOT_DDATA by performing a convolution calculation on the first image capture data PDATA1 and the weight matrix W. In some embodiments, the convolution calculator 2212 may be omitted, and the calculator 2220 may generate the deblurring dot data DOT_DDATA.

The error calculator 2213 may calculate the error ERROR between the deblurring dot data DOT_DDATA and the ideal dot data DOT_DDATA_IDEAL. In some embodiments, the ideal dot data DOT_DDATA_IDEAL may be acquired by binarizing the image capture data PDATA (e.g., first image capture data PDATA1). The error ERROR may be provided to the matrix generator 2211 or a separate controller, and be used to change or adjust the first and second entry values P and Q.

In an embodiment, the error calculator 2213 may calculate a mean squared error between the deblurring dot data DOT_DDATA and the ideal dot data DOT_DDATA_IDEAL.

Referring to FIG. 12, the deblurring dot data DOT_DDATA with respect to a deblurring dot pattern DOT_D may be expressed as a block having a size of 7×7. However, the size of the block is not limited thereto, and may be variously set between the size (e.g., 3×3) of the weight matrix W and the size (e.g., 40×40) of the reference block BLK. The weight matrix W is used to define a degree to which the dot pattern is diffused or blurred in the first image capture data PDATA1 (e.g., a relative relationship between adjacent values), and therefore, the error calculator 2213 may normalize the deblurring dot data DOT_DDATA in units of blocks. For example, the error calculator 2213 may normalize the deblurring dot data DOT_DDATA such that a total sum of values included in a block having a size of 7×7 becomes about 1.

Subsequently, the error calculator 2213 may calculate a mean squared error by performing a subtraction calculation on corresponding values between the deblurring dot data DOT_DDATA (or normalized deblurring dot data) and the ideal dot data DOT_DDATA_IDEAL.

In an embodiment, the error calculator 2213 may calculate a mean squared error by normalizing the deblurring dot data DOT_DDATA for each of the positions of the dot patterns DOT 11 to DOT 13 and DOT 21 to DOT 23 (see FIG. 8), and calculate the error ERROR by entirely accumulating the mean squared error corresponding to each of the dot patterns DOT 11 to DOT 13 and DOT 21 to DOT 23 (see FIG. 8).

In an embodiment, the error calculator 2213 (or the weight matrix generator 2210) may sequentially adjust the first entry value P and the second entry value Q.

For example, the error calculator 2213 may update the first entry value P by using the Gradient Descent Algorithm (GDA). For example, the error calculator 2213 may calculate a variation of the error ERROR by changing only the first entry value P among the first and second entry values P and Q, decrease a learning rate (for example, a change rate of the error ERROR) in case that the error ERROR is decreased, and change the first entry value P, based on the learning rate and the variation of the error ERROR.

Subsequently, the error calculator 2213 may update the second entry value Q by using the Gradient Descent Algorithm (GDA). For example, the error calculator 2213 may calculate a variation of the error ERROR by changing only the second entry value Q among the first and second entry values P and Q, decrease a learning rate in case that the error ERROR is decreased, and change the second entry value Q, based on the learning rate and the variation of the error ERROR.

The error calculator 2213 may sequentially repeat updating of the first entry value P and the second entry value Q by using the Gradient Descent Algorithm (GDA), until the first entry value P is not changed (or updated). In other words, in case that the first entry value P is not changed or is no longer updated in the updating process, the error calculator 2213 may suspend machine learning, and generate the weight matrix W (for example, an optimized weight matrix), based on the finally updated first and second entry values P and Q.

Referring back to FIG. 7, the calculator 2220 may generate first deblurring data DDATA1 by deblurring second image capture data PDATA2, using the weight matrix W. The second image capture data PDATA2 may be image capture data acquired in a state in which an image (or second image) is displayed by allowing all pixels (e.g., pixels expressing a same color) of the display device 1000 to emit light. The first deblurring data DDATA1 may be provided as the deblurring data DDATA (see FIG. 5) to the compensation value calculation block 2300. However, the disclosure is not limited thereto.

For example, the calculator 2220 may generate the first deblurring data DDATA1 by performing a convolution calculation on the second image capture data DATA2 and the weight matrix W.

As shown in FIG. 13, the calculator 2220 may perform a convolution calculator while shifting the weight matrix W in units of pixels. For example, a value of 131 may be acquired by performing a convolution calculation on values 98, 101, 103, 105, 120, 109, 103, 118, and 115 and the weight matrix W. Thus, a luminance value of each of the pixels PX in the display device 1000 can be more accurately acquired through the first deblurring data DDATA1.

As described above, the deblurring bock 2200 may derive a weight matrix W (or blur information) through machine learning on first image capture data PDATA1 including dot patterns (or blurred dot patterns), and may generate first deblurring data DDATA1 (or deblurring data DDATA) by deblurring second image capture data PDATA2, based on the weight matrix W. Since the first deblurring data DDATA1 is deblurred in the unit of a pixel PX, the first deblurring data DDATA1 can include a more accurate luminance value with respect to each of the pixels PX in the display device 1000. In other words, a problem caused by a blur can be solved, and image capture accuracy can be improved.

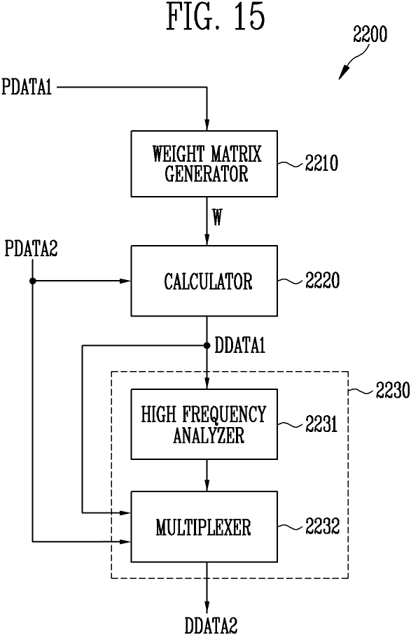

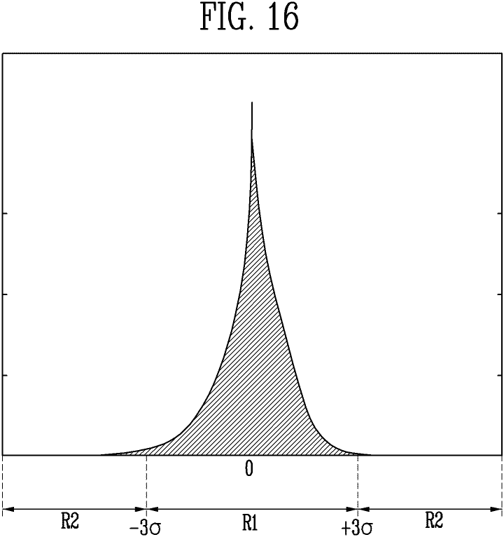

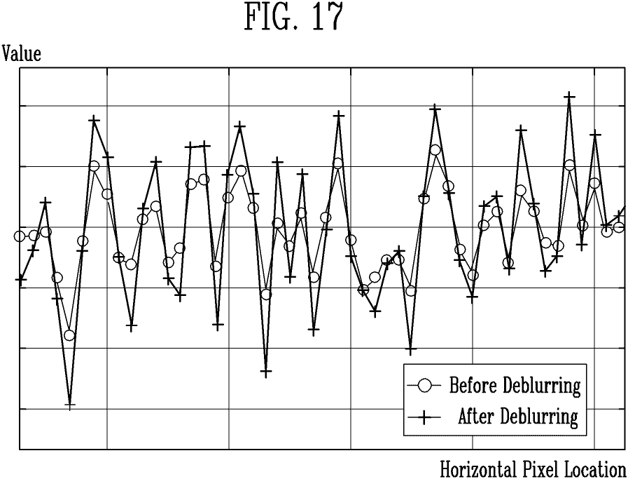

FIGS. 14 and 15 are schematic diagrams illustrating another embodiment of the deblurring block included in the luminance correction device shown in FIG. 5. FIG. 16 is a schematic diagram illustrating an operation of a noise canceller included in the deblurring block shown in FIGS. 14 and 15. FIG. 16 illustrates a spatial frequency histogram (or spatial histogram) with respect to first deblurring data.

Referring to FIGS. 7, 14, and 15, the deblurring block 2200 may further include a noise canceller 2230 (or partial deblur).

The noise canceller 2230 may generate second deblurring data DDATA2 by cancelling a noise (artifact) generated in the first deblurring data DDATA1 in a deblurring process. The noise may be an excessively deblurred value. The second deblurring data DDATA2 may be provided as the deblurring data DDATA (see FIG. 5) to the compensation value calculation block 2300.

In an embodiment, the noise canceller 2230 may detect a value (or position thereof) at which the noise occurs through a spatial frequency analysis on the first deblurring data DDATA1, and replace the value with a value (for example, an original value which is not deblurred) in the second image capture data PDATA2.

In an embodiment, as shown in FIG. 15, the noise canceller 2230 may include a high frequency analyzer 2231 and a multiplexer 2232.

The high frequency analyzer 2231 may perform the spatial frequency analysis on the first deblurring data DDATA1. For example, the high frequency analyzer 2231 may perform the spatial frequency analysis on the first deblurring data DDATA1 by an average filter.

Referring to FIG. 16, it may be expressed that a spatial frequency histogram with respect to the first deblurring data DDATA1 has a normal distribution (e.g., a Gaussian distribution) with respect to an average value (e.g., about 0). For example, the high frequency analyzer 2231 may determine that values included in a first period R1 (e.g., a period between ±3σ) which is within a standard deviation are normally deblurred, and determine that values included in a second period R2 (e.g., a period exceeding ±3σ) which is out of the standard deviation are excessively deblurred. The high frequency analyzer 2231 may provide the multiplexer 2232 with position information on the values (or pixels) included in the second period R2.

The multiplexer 2232 may receive the first deblurring data DDATA1 and the second image capture data PDATA2, and replace a portion of the first deblurring data DDATA1 with a value of the second image capture data PDATA2, based on the position information provided from the high frequency analyzer 2231. An example will be described with reference to FIG. 13. The first deblurring data DDATA1 may include a value of 131, and the multiplexer 2232 may replace the value of 131 with a value of 120 (for example, an original value), which is included in the second image capture data PDATA2. For example, the multiplexer 2232 outputs a value of the first deblurring data DDATA1, and may select and output the value of the second image capture data PDATA2 instead of the value of the first deblurring data DDATA1 in response to the position information.

Although it is described that the multiplexer 2232 selects and outputs the value of the second image capture data PDATA2, based on the position information, the disclosure is not limited thereto. For example, the multiplexer 2232 may output a value (e.g., a predetermined or selectable value) instead of the value of the second image capture data PDATA2.

As described above, the deblurring block 2200 may detect and cancel a noise through the spatial frequency analysis on the first deblurring data DDATA1. Thus, the second deblurring data DDATA2 can include a more accurate luminance value with respect to each of the pixels PX in the display device 1000. In other words, image capture accuracy can be further improved.

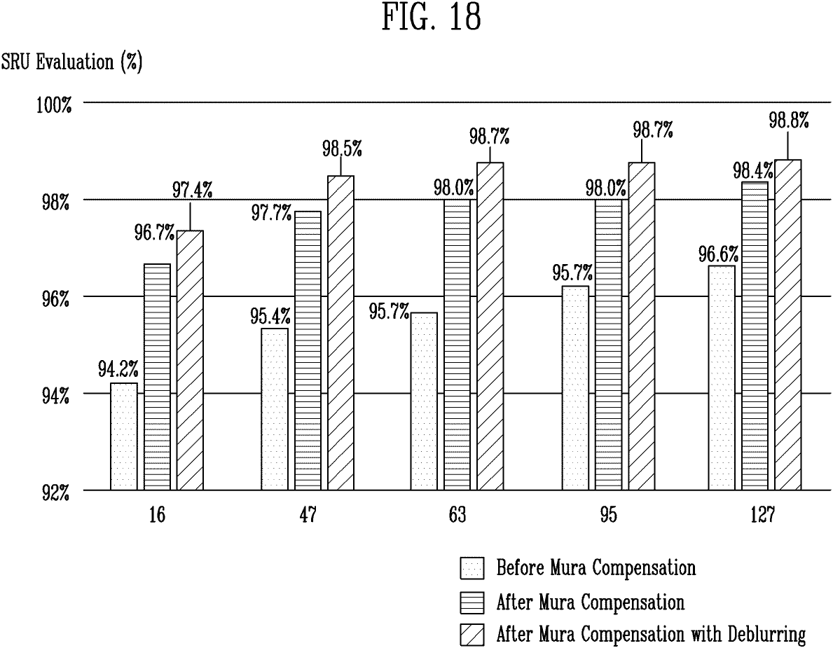

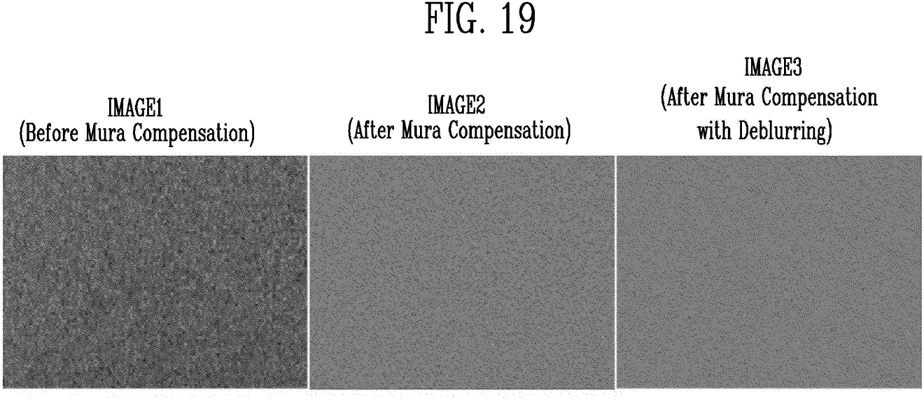

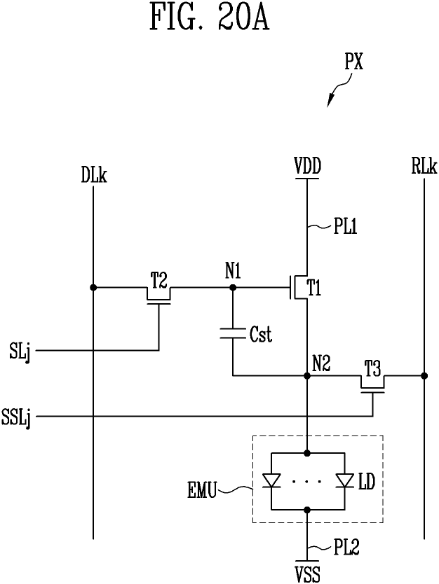

FIGS. 17 to 19 are schematic diagrams illustrating an effect of deblurring on image capture data. FIG. 17 illustrates values (or luminance values) included in a horizontal line of image capture data. FIG. 18 illustrates short range uniformity (SRU) of the display device 1000 according to whether luminance correction (or mura compensation) and deblurring are to be applied. The SRU means luminance uniformity between adjacent pixels. FIG. 19 illustrates images of a single grayscale, which are displayed in the display device 1000.

Referring to FIG. 17, it can be seen that in case that deblurring is performed on image capture data, adjacent luminance values are clearly distinguished from each other, as compared with when the deblurring is not performed on the image capture data.

FIG. 18 illustrates SRU of the display device 1000 displaying an image of a single grayscale of 16, 47, 63, 95 or 127.

In case that luminance correction (or mura compensation) using the compensation value CV (see FIGS. 4 and 5) is not performed, the SRU exhibited within a range of about 94.2% to about 96.6%. In case that the luminance correction (or mura compensation) is performed by using a compensation value CV generated based on image capture data on which the deblurring is not performed, the SRU exhibited within a range of about 96.7% to about 98.4%. In case that the luminance correction (or mura compensation) is performed by using a compensation value CV generated based on image capture data on which the deblurring is performed (for example, in case that the mura compensation is performed in the unit of a size of 1×1), the SRU exhibited within a range of about 97.4% to about 98.8%, which is higher than the SRU in case that the deblurring is not performed. For example, it can be seen that the SRU is improved through the deblurring on the image capture data.

Referring to FIG. 19, each of a first display image IMAGE1, a second display image IMAGE2, and a third display image IMAGE3 may correspond to a specific single grayscale (e.g., a single grayscale of 127). The first display image IMAGE1 may be an image displayed in the display device 1000 in which a compensation operation using a compensation value CV is not performed. The second display image IMAGE2 may be an image displayed in the display device 1000 using a compensation value generated based on image capture data on which the deblurring is not performed. The third display image IMAGE3 may be an image displayed in the display device 1000 using a compensation value CV generated based on image capture data on which the deblurring is performed. In the case of the first display image IMAGE1, a relatively dark or bright mura may be viewed. In the case of the second display image IMAGE2 and the third display image IMAGE3, any mura is hardly viewed, and particularly, a more uniform luminance is provided as compared with the case of the third display image IMAGE3.

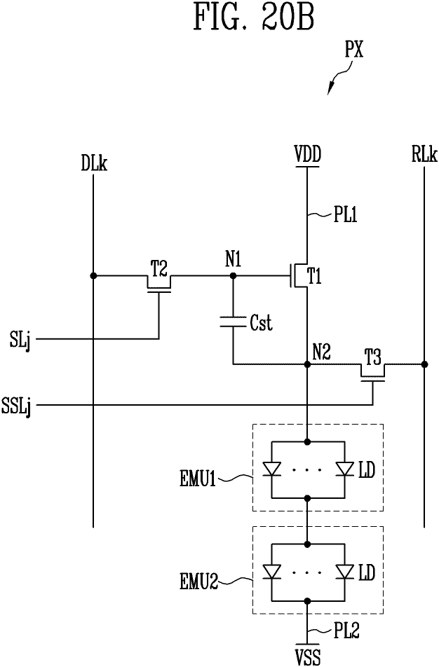

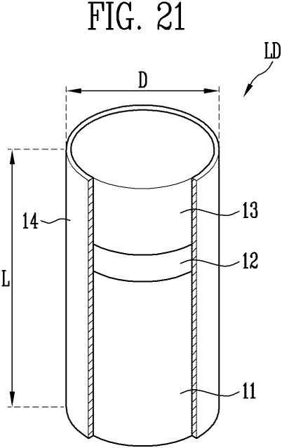

FIGS. 20A and 20B are schematic diagrams of equivalent circuits illustrating an embodiment of the pixel included in the display device shown in FIG. 4. For convenience of description, a pixel PX which is located on a jth row (horizontal line) and located on a kth column is illustrated in FIGS. 20A and 20B.

Referring to FIGS. 20A and 20B, the pixel PX may include a light emitting element LD, a first transistor T1 (driving transistor), a second transistor T2, a third transistor T3, and a storage capacitor Cst.

A first electrode (anode or cathode) of the light emitting element LD may be connected to a second node N2, and a second electrode (cathode or anode) of the light emitting element LD may be connected to the second driving voltage VSS through a second power line PL2. The light emitting element LD may generate light with a luminance (e.g., a predetermined or selectable luminance) corresponding to an amount of current supplied from the first transistor T1.

In an embodiment, the pixel PX may include light emitting elements LD, and the light emitting elements LD may be connected in parallel to each other. As shown in FIG. 20A, the light emitting elements LD may constitute a light source EMU (or light emitting unit). Some of the light emitting elements LD may have different emission characteristics (e.g., different current-luminance characteristics), and a number of light emitting elements LD may be different for each pixel PX. For example, light emitting elements LD may be dispersed in a solvent to be supplied to each pixel PX by an inkjet process. However, the light emitting elements LD may not be uniformly dispersed in the solvent. For example, the light emitting elements LD are connected between the second node N2 and the second power line PL2 by a separate alignment process, and a number of light emitting elements LD normally aligned in the alignment process may not be uniform for each pixel PX. Accordingly, a luminance deviation may occur between adjacent pixels PX. In particular, a relatively large luminance deviation may exhibit as compared with when the pixel PX includes only a light emitting element LD.

In another embodiment, the light emitting elements LD may constitute (or form) light sources. As shown in FIG. 20B, some of the light emitting elements LD may be connected in parallel to each other to constitute a first light source EMU1, and the others of the light emitting elements LD may be connected in parallel to each other to constitute a second light source EMU2. The first light source EMU1 and the second light source EMU2 may be connected in series to each other between the second node N2 and the second power line PL2. The third capture image IMAGE_P3 and/or the second capture image IMAGE_P2, shown in FIG. 2, may exhibit.

A first electrode of the first transistor T1 (or driving transistor) may be connected to the first driving voltage VDD through a first power line PL1, and a second electrode of the first transistor T1 may be the first electrode of the light emitting element LD. A gate electrode of the first transistor T1 may be connected to a first node N1. The first transistor T1 may control an amount of current flowing through the light emitting element LD, corresponding to a voltage of the first node N1.

A first electrode of the second transistor T2 may be connected to a data line DLk, and a second electrode of the second transistor T2 may be connected to the first node N1. A gate electrode of the second transistor T2 may be connected to a scan line SLj. The second transistor T2 may be turned on in case that a gate signal is supplied to the scan line SLj, to transfer a data signal from the data line DLk to the first node N1.

The third transistor T3 may be connected between a read line RLk and the second electrode of the first transistor T1 (for example, the second node N2). For example, a first electrode of the third transistor T3 may be connected to the read line RLk, a second electrode of the third transistor T3 may be connected to the second electrode of the first transistor T1, and a gate electrode of the third transistor T3 may be connected to a sensing control line SSLj. The third transistor T3 may be turned on in case that a control signal is supplied to the sensing control line SSLj, to electrically connect the read line RLk and the second node N2 (for example, the second electrode of the first transistor T1) to each other.

In an embodiment, in case that the third transistor T3 is turned on, the initialization voltage VINT (see FIG. 4) to the second node N2. In another embodiment, in case that the third transistor T3 is turned on, a current generated from the first transistor T1 may be supplied to the sensing unit (not shown).

The storage capacitor Cst may be connected between the first node N1 and the second node N2. The storage capacitor Cst may store a voltage corresponding to a voltage difference between the first node N1 and the second node N2.

In the embodiment of the disclosure, the circuit structure of the pixel PX is not limited by FIGS. 20A and 20B. In an example, the light emitting element LD may be located between the first power line pL1 and the first electrode of the first transistor T1. A parasitic capacitor may be formed between the gate electrode of the first transistor T1 (for example, the first node N1) and a drain electrode of the first transistor T1.

Although FIGS. 20A and 20B illustrate that the transistors T1, T2, and T3 are implemented as an NMOS transistor, the disclosure is not limited thereto. In an example, at least one of the transistors T1, T2, and T3 may be implemented as a PMOS transistor. The transistors T1, T2, and T3 shown in FIGS. 20A and 20B may be implemented as a thin film transistor including at least one of an oxide semiconductor, an amorphous silicon semiconductor, and a polycrystalline silicon semiconductor.

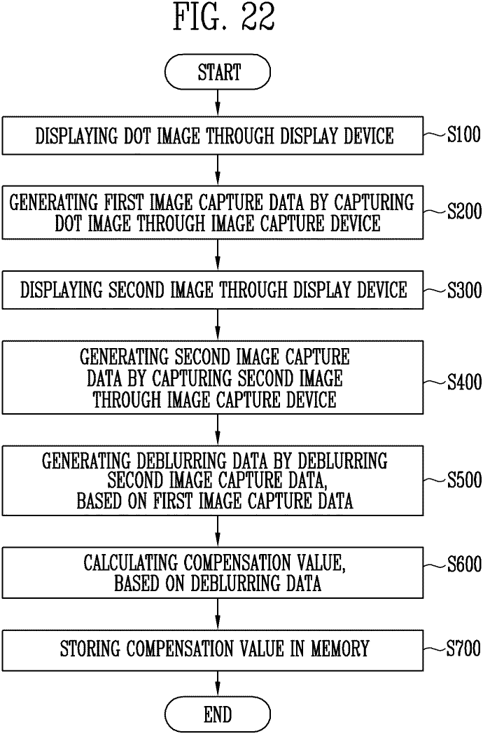

Hereinafter, a light emitting element in accordance with an embodiment of the disclosure will be described with reference to FIG. 21.

FIG. 21 is a schematic perspective view illustrating the light emitting element included in the pixel shown in FIG. 20A.

Referring to FIG. 21, the light emitting element LD includes a first semiconductor layer 11, a second semiconductor layer 13, and an active layer 12 located between the first semiconductor layer 11 and the second semiconductor layer 13. In an example, the light emitting element LD may be configured as a stack structure in which the first semiconductor layer 11, the active layer 12, and the third semiconductor layer 13 are sequentially stacked each other in a length L direction.

The light emitting element LD may be provided in a rod shape extending in a direction, for example, a cylindrical shape. Assuming that an extending direction of the light emitting element LD is the length L direction, the light emitting element LD may have an end portion and another end portion in the length L direction. Although FIG. 21 illustrates a pillar-shaped light emitting element LD, the kind and/or shape of the light emitting element LD in accordance with the embodiment of the disclosure is not limited thereto. A length L and a width (or diameter) D of the light emitting element LD may be in a range of nanometers to micrometers but are not limited thereto.

The first semiconductor layer 11 may include at least one n-type semiconductor layer. For example, the first semiconductor layer 11 may include any one semiconductor material among InAlGaN, GaN, AlGaN, InGaN, AlN, and InN, and be an n-type semiconductor layer doped with a first conductivity type dopant such as Si, Ge or Sn. However, the material constituting the first semiconductor layer 11 is not limited thereto. The first semiconductor layer 11 may be configured with (or formed as/with) various materials.

The active layer 12 is disposed on the first semiconductor layer 11, and may be formed in a single-quantum well structure or a multi-quantum well structure. In an embodiment, a clad layer (not shown) doped with a conductive dopant may be formed on the top and/or the bottom of the active layer 12. In an example, the clad layer may be formed as an AlGaN layer or an InAlGaN layer. In some embodiments, a material such as AlGaN or AlInGaN may be used to form the active layer 12. The active layer 12 may be configured with various materials.

In case that a voltage substantially equal to or higher than a threshold voltage is applied to ends of the light emitting element LD, the light emitting element LD emits light as electron-hole pairs are combined in the active layer 12. The light emission of the light emitting element LD is controlled by using such a principle, so that the light emitting element LD can be used as a light source for various light emitting devices, including a pixel of a display device.

The second semiconductor layer 13 may be disposed on the active layer 12, and include a semiconductor layer of a type different from the type of the first semiconductor layer 11. In an example, the second semiconductor layer 13 may include at least one p-type semiconductor layer. For example, the second semiconductor layer 13 may include at least one semiconductor material among InAlGaN, GaN, AlGaN, InGaN, AlN, and InN, and include a P-type semiconductor layer doped with a second conductivity type dopant such as Mg, Zn, Ca, Sr or Ba. However, the material constituting the second semiconductor layer 13 is not limited thereto. The second semiconductor layer 13 may be formed of various materials.

In the above-described embodiment, it is described that each of the first semiconductor layer 11 and the second semiconductor layer 13 is configured with one layer. However, the disclosure is not limited thereto. In an embodiment of the disclosure, each of the first semiconductor layer 11 and the second semiconductor layer 13 may further include at least one layer, e.g., a clad layer and/or a tensile strain barrier reducing (TSBR) layer according to the material of the active layer 12. The TSBR layer may be a strain reducing layer disposed between semiconductor layers having different lattice structures to perform a buffering function for reducing a lattice constant difference. The TSBR layer may be configured with a p-type semiconductor layer such as p-GAInP, p-AlInP or p-AlGaInP, but the disclosure is not limited thereto.

In some embodiments, the light emitting element LD may further include an insulative layer 14 provided on a surface thereof. The insulative film 14 may be formed on the surface of the light emitting element LD to surround an outer circumferential surface of the active layer 12. The insulative film 14 may further surround an area of each of the first semiconductor layer 11 and the second semiconductor layer 13. However, in some embodiments, the insulative film 14 may expose end portions of the light emitting element LD, which have different polarities. For example, the insulative film 14 does not cover ends of the first semiconductor layer 11 and the second semiconductor layer 13, which are located at ends of the light emitting element LD in the length L direction, e.g., two bottom surfaces of a cylinder (an upper surface and a lower surface of the light emitting element LD), but may expose the ends of the first semiconductor layer 11 and the second semiconductor layer 13.

In case that the insulative film 14 is provided on the surface of the light emitting element LD, particularly, a surface of the active layer 12, the active layer 12 can be prevented from being short-circuited with at least one electrode (not shown) (e.g., at least one contact electrode among contact electrodes connected to the ends of the light emitting element LD), etc. Accordingly, the electrical stability of the light emitting element LD can be ensured.

The light emitting element LD includes the insulative film 14 on the surface thereof, so that a surface defect of the light emitting element LD can be reduced or minimized, thereby improving the lifespan and efficiency of the light emitting element LD. Further, in case that each light emitting element LD includes the insulative film 14, an unwanted short circuit can be prevented from occurring between light emitting elements LD even in case that the light emitting elements LD are densely disposed.

In an embodiment, the light emitting element LD may be manufactured by a surface treatment process. For example, in case that light emitting elements LD are mixed in a liquid solution (or solvent) to be supplied to each emission area (e.g., an emission area of each pixel), each light emitting element LD may be surface-treated such that the light emitting elements LD are not unequally condensed in the solution but equally dispersed in the solution.

In an embodiment, the light emitting element LD may further include an additional component in addition to the first semiconductor layer 11, the active layer 12, the second semiconductor layer 13, and the insulative film 14. For example, the light emitting element LD may additionally include at least one phosphor layer, at least one active layer, at least one semiconductor layer, and/or at least one electrode layer, which are disposed at ends of the first semiconductor layer 11, the active layer 12, and the second semiconductor layer 13.

The light emitting element LD may be used in various kinds of devices which require a light source, including a display device. For example, at least one light emitting element LD, e.g., light emitting elements LD each having a size of nanometer scale to micrometer scale may be disposed in each pixel area of a display device, and a light source (or light source unit) of each pixel may be configured using the light emitting elements LD. However, the application field of the light emitting element LD is not limited to the display device. For example, the light emitting element LD may be used in other types of devices that require a light source, such as a lighting device.

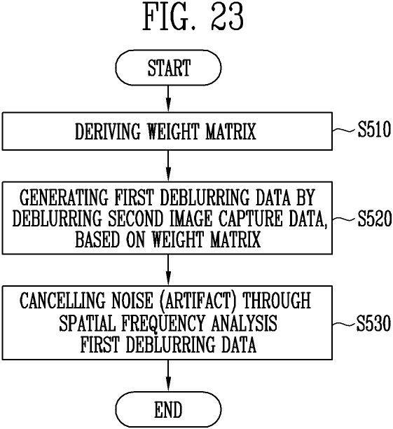

FIG. 22 is a schematic flowchart illustrating an optical compensation method in accordance with embodiments of the disclosure.

Referring to FIGS. 1, 7, and 22, the optical compensation method shown in FIG. 22 may be performed in the optical compensation system 10 shown in FIG. 1.

In the optical compensation method shown in FIG. 22, a dot image IMAGE_DOT (see FIG. 8) (or first image) may be displayed through the display device 1000 (S100).

In the optical compensation method shown in FIG. 22, first image capture data PDATA1 may be generated by capturing the dot image IMAG_DOT (or the display device 1000 displaying the dot image IMAG_DOT) by the image capture device 3000 (S200).

As described with FIG. 5, in the optical compensation method shown in FIG. 22, a resolution of the first image capture data PDATA1 may be converted to be substantially equal to a resolution of the display device 1000 through image warping.

In the optical compensation method shown in FIG. 22, a second image may be displayed through the display device 1000 (S300). As described with reference to FIG. 7, the second image may be an image obtained by allowing all pixels (e.g., pixels expressing a same color) of the display device 1000 to emit light.

In the optical compensation method shown in FIG. 22, second image capture data PDATA2 may be generated by capturing the second image by the image capture device 3000 (S400).

In the optical compensation method shown in FIG. 22, deblurring data DDATA may be generated by deblurring the second image capture data, based on the first image capture data, by the luminance correction device 2000 (see FIG. 5) (S500).

Subsequently, in the optical compensation method shown in FIG. 22, a compensation value CV (compensation coefficient or compensation data) may be calculated based on the deblurring data DDATA by the luminance correction device 2000 (S600). In the optical compensation method shown in FIG. 22, the compensation value CV may be stored in the memory 500 of the display device 1000 (S700).

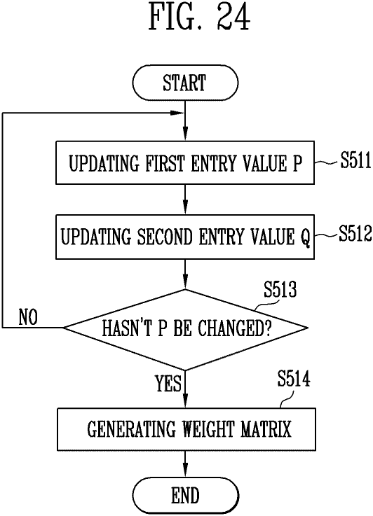

FIG. 23 is a schematic flowchart illustrating a process of deblurring the second image capture data shown in FIG. 22.

Referring to FIGS. 7, 14, 22, and 23, in a method (or image processing method) shown in FIG. 23, blur information or a weight matrix W may be derived based on the first image capture data PDATA1 (S510). The blur information may mean a degree to which a capture image is blurred, and an inverse matrix of the weight matrix may correspond to the blur information. As described with reference to FIG. 7, in the method shown in FIG. 23, the weight matrix W may be derived through machine learning on the first image capture data PDATA1, e.g., machine learning using a Gradient Descent Algorithm (GDA) (S510).

As described with reference to FIG. 11, in the method shown in FIG. 23, deblurring dot data DOT_DDATA including a deblurring dot pattern DOT_D may be calculated by using the weight matrix W, an error ERROR between ideal dot data DOT_DDATA_IDEAL including an ideal dot pattern DOT_IDEAL and the deblurring dot data DOT_DDATA may be calculated, and entry values (or weighted values) of the weight matrix W may be adjusted based on the error ERROR. In the method shown in FIG. 23, the calculating of the error ERROR and the adjusting of the entry values may be repeated such that the error ERROR is minimized.

In some embodiments, the deriving of the weight matrix W may be performed after the first image capture data PDATA1 is acquired, or be performed after the second image capture data PDATA2 is acquired.

Subsequently, in the method shown in FIG. 23, first deblurring data DDATA1 may be generated by deblurring the second image capture data PDATA2, based on the blur information or the weight matrix W (S520).

Subsequently, in the method shown in FIG. 23, a noise (artifact) may be detected and cancelled through a spatial frequency analysis on the first deblurring data DDATA1 (S530).

As described with reference to FIG. 14, in the method shown in FIG. 23, the noise generated in the first deblurring data DDATA1 may be replaced with a value of the second image capture data PDATA2.

FIG. 24 is a schematic flowchart illustrating a process of deriving the weight matrix shown in FIG. 23.

Referring to FIGS. 11, 23, and 24, in a method shown in FIG. 24, an optimum weight matrix W may be determined by sequentially/repeatedly adjusting a first entry value P and a second entry value Q of the weight matrix W.

As described with reference to FIG. 11, in the method shown in FIG. 24, the first entry value P may be updated by using the Gradient Descent Algorithm (GDA) (S511), and the second entry value Q may be updated by using the Gradient Descent Algorithm (GDA) (S512).

In the method shown in FIG. 24, it may be determined whether the first entry value P has been changed (or updated) (S513). In case that the first entry value P is changed (e.g., in case that the first entry value P is updated as a new value or a value out of a reference range), in the method shown in FIG. 24, the updating of the first and second entry values P and Q may be repeated. As another example, in case that the first entry value P is not changed, or in case that the first entry value P1 is updated within the reference range (e.g., a range of about 1% or less), in the method shown in FIG. 24, the updating of the first and second entry values P and Q (or repeating thereof) may be suspended. In the method shown in FIG. 24, the weight matrix W may be generated by using the finally updated first and second entry values P and Q (S514).

In the image processing method, an optical compensation method, and an optical compensation system in accordance with the disclosure, blur information representing a degree of blur occurring in image capturing is acquired based on a first image capture data acquired by capturing a first image including a dot pattern, and second image capture data about a second image (for example, an image for generating compensation data) is deblurred based on the blur information. Thus, a problem of blur occurring in second image capture data can be solved through the deblurring, image capture accuracy can be improved, and a more appropriate compensation data for luminance compensation can be generated.

The above description is an example of technical features of the disclosure, and those skilled in the art to which the disclosure pertains will be able to make various modifications and variations. Thus, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. An optical compensation method comprising:
displaying a first image in a display device, the first image including a dot pattern obtained by allowing target pixels spaced apart from each other emit light, at least two other pixels being disposed between the target pixels;
generating first image capture data by capturing the first image displayed in the display device through an image capture device;
displaying a second image in the display device;
generating second image capture data by capturing the second image displayed in the display device through the image capture device;
generating deblurring data by deblurring the second image capture data, based on the first image capture data;
generating compensation data for luminance correction of the display device, based on the deblurring data; and
storing the compensation data in a memory device.

2. The optical compensation method of claim 1, wherein
the first image includes areas divided with respect to a reference block, and
in each of the areas, a target pixel among the target pixels emits light, and adjacent pixels adjacent to the target pixel emit no light, thereby expressing the dot pattern.

3. The optical compensation method of claim 1, wherein
the dot pattern is blurredly captured according to at least one of an image capture condition and a resolution of the image capture device, and
the first image capture data includes a blurred dot pattern corresponding to the dot pattern.

4. The optical compensation method of claim 1, wherein
the generating of the deblurring data includes:
detecting blur information representing a degree to which the dot pattern is blurred in an image captured by the image capture device, based on the first image capture data; and
deblurring the second image capture data, based on the blur information.

5. The optical compensation method of claim 4, wherein the detecting of the blur information includes deriving a weight matrix for converting the blurred dot pattern included in the first image capture data into an ideal dot pattern.

6. The optical compensation method of claim 5, wherein
the deriving of the weight matrix includes calculating a first weighted value for a target pixel among the target pixels corresponding to the dot pattern and a second weighted value for adjacent pixels adjacent to the target pixel through machine learning on the blurred dot pattern, and
the first weighted value and the second weighted value are included in the weight matrix.

7. The optical compensation method of claim 6, wherein a gradient descent algorithm is used for the machine learning.

8. The optical compensation method of claim 6, wherein the deriving of the weight matrix includes:
calculating deblurring dot data including a deblurring dot pattern by using the weight matrix;
calculating an error between ideal dot data including an ideal dot pattern and the deblurring dot data; and
adjusting the first weighted value and the second weighted value, based on the error.

9. The optical compensation method of claim 8, wherein the deriving of the weight matrix includes repeating the calculating of the error and the adjusting of the first weighted value and the second weighted value such that the error is minimized.

10. The optical compensation method of claim 8, wherein, in the calculating of the error, the error is calculated by normalizing the first image capture data.

11. The optical compensation method of claim 4, wherein the generating of the deblurring data further includes:
generating first deblurring data by deblurring the second image capture data;
detecting a noise through a spatial frequency analysis on the first deblurring data, the noise being a deblurred value out of a reference range in the deblurring of the second image capture data; and
replacing the noise with a value corresponding to the second image capture data.

12. The optical compensation method of claim 1, wherein the generating of the first image capture data includes converting a resolution of an image captured by the image capture device to be substantially equal to a resolution of the display device.

13. The optical compensation method of claim 1, wherein the compensation data stored in the memory device is used for luminance deviation compensation in driving of the display device.

14. An image processing method of preprocessing a capture image for optical compensation of a display device, the image processing method comprising:
detecting blur information representing a degree to which a dot pattern is blurred in a first capture image including the dot pattern; and
deblurring a second capture image, based on the blur information.

15. The image processing method of claim 14, wherein the detecting of the blur information includes deriving a weight matrix for converting the blurred dot pattern included in the first capture image into an ideal dot pattern.

16. The image processing method of claim 15, wherein
the deriving of the weight matrix includes calculating a first weighted value for a target pixel corresponding to the dot pattern and a second weighted value for adjacent pixels adjacent to the target pixel through machine learning on the blurred dot pattern, and
the first weighted value and the second weighted value are included in the weight matrix.

17. The image processing method of claim 16, wherein a gradient descent algorithm is used for the machine learning.

18. The image processing method of claim 16, wherein the deriving of the weight matrix includes:
generating a deblurring dot image including a deblurring dot pattern by using the weight matrix;
calculating an error between an ideal dot image including an ideal dot pattern and the deblurring dot image; and
adjusting the first weighted value and the second weighted value, based on the error.

19. The image processing method of claim 14, wherein the deblurring of the second captured image further includes:
generating a first deblurring image by deblurring the second capture image;
detecting a noise through a spatial frequency analysis on the first deblurring image, the noise being a deblurred value out of a reference range in the deblurring of the second capture image; and
replacing the noise with a value corresponding to the second capture image.

20. An optical compensation system comprising:
an image capture device that generates image capture data by capturing an image displayed in a display device; and
a luminance correction device that generates compensation data for luminance correction of the display device, based on the image capture data,
wherein the luminance correction device detects blur information representing a degree to which a dot pattern is blurred in first image capture data including the dot pattern, and deblurs second image capture data, based on the blur information.
